(19) United States
(12) Patent Application Publication
(10) Pub. No.: US 2025/0076678 A1
(43) Pub. Date: Mar. 6, 2025

(54) WEARABLE DEVICE AND HEAD STRAP MODULE

(71) Applicant: HTC Corporation, Taoyuan City (TW)

(72) Inventors: Tung-Ting Cheng, Taoyuan City (TW); Ming Siang Huang, Taoyuan City (TW)

(73) Assignee: HTC Corporation, Taoyuan City (TW)

(21) Appl. No.: 18/741,793

(22) Filed: Jun. 13, 2024

Related U.S. Application Data
(60) Provisional application No. 63/534,870, filed on Aug. 28, 2023.

(51) Int. Cl. G02C 3/00; G02B 27/01

(52) U.S. Cl. CPC G02C 3/003; G02B 27/0176; G02B 2027/0178

(57) ABSTRACT

A wearable device includes a host, a pair of temple arms, and a head strap module. The pair of temple arms are connected to two opposite sides of the host. The head strap module includes a pair of connectors, a pair of swivel rings, a pair of buckles, and a support strap. The pair of connectors are respectively detachably connected to the pair of first temple arms. The pair of swivel rings are respectively connected to the pair of connectors. The support strap has a bridging section, a limiting section, and a pair of extension sections. The limiting section is located at a first end of the bridging section. One of the pair of extension sections is connected to a second end of the bridging section opposite to the first end and extended through the swivel ring, the buckle, and the limiting section sequentially and fixed to the buckle. The other of the pair of extension sections is connected to the second end of the bridging section and extended through the other swivel ring, the other buckle, and the limiting section sequentially and fixed to the other buckle. The pair of buckles are respectively moveable on the pair of extension sections to adjust an overlapping length of the pair of extension sections between the pair of buckles. A head strap module is also provided herein.

### CROSS-REFERENCE TO RELATED APPLICATION

This application claims the priority benefit of U.S. provisional application Ser. No. 63/534,870, filed on Aug. 28, 2023. The entirety of the above-mentioned patent application is hereby incorporated by reference herein and made a part of this specification.

### BACKGROUND

### Technical Field

The present application relates to a wearable device, and in particular to a wearable device and a head strap module.

### Description of Related Art

As the technology industry becomes increasingly developed, the types, functions of use, and methods of use of display devices are becoming more diverse, and wearable display devices that may be worn directly on the body of the user have also emerged accordingly. There are many types of head-mounted display devices. Take a glasses-type head-mounted display device as an example. After the user wears this type of display device, in addition to seeing three-dimensional images, the image is also changed as the head of the user turns, providing the user with a more immersive experience. However, when the user is playing games and the movements are too intense, a pair of temple arms of the glasses-type head-mounted display device may not provide sufficient clamping force.

### SUMMARY

The present application provides a wearable device reducing the risk of the host thereof falling and increasing wear stability via an additional head strap module.

The present application provides a head strap module suitable for a wearable device to reduce the risk of the host of the wearable device falling and increase wear stability.

A wearable device of the present application includes a host, a first temple arm, a second temple arm, and a head strap module. The first temple arm and the second temple arm are respectively connected to two opposite sides of the host. The head strap module includes a first connector, a second connector, a first swivel ring, a second swivel ring, a first buckle, a second buckle, and a support strap. The first connector is detachably connected to the first temple arm. The second connector is detachably connected to the second temple arm. The first swivel ring is connected to the first connector. The second swivel ring is connected to the second connector. The support strap has a bridging section, a limiting section, a first extension section, and a second extension section. The limiting section is located at a first end of the bridging section. The first extension section is connected to a second end of the bridging section relative to the first end and extended through the first swivel ring, the first buckle, and the limiting section sequentially and fixed to the second buckle. The second extension section is connected to the second end of the bridging section and extended through the second swivel ring, the second buckle, and the limiting section sequentially and fixed to the first buckle. The first buckle is movable on the first extension section. The second buckle is movable on the second extension section. A movement of the first buckle on the first extension section and a movement of the second buckle on the second extension section may adjust an overlapping length of the first extension section and the second extension section between the first buckle and the second buckle.

A head strap module of the present application is suitable for a wearable device. The wearable device includes a host, a first temple arm, and a second temple arm. The first temple arm and the second temple arm are respectively connected to two opposite sides of the host. The head strap module includes a first connector, a second connector, a first swivel ring, a second swivel ring, a first buckle, a second buckle, and a support strap. The first connector is suitable for being detachably connected to the first temple arm. The second connector is suitable for being detachably connected to the second temple arm. The first swivel ring is connected to the first connector. The second swivel ring is connected to the second connector. The support strap has a bridging section, a limiting section, a first extension section, and a second extension section. The limiting section is located at a first end of the bridging section, the first extension section is connected to a second end of the bridging section relative to the first end and extended through the first swivel ring, the first buckle, and the limiting section sequentially and fixed to the second buckle. The second extension section is connected to the second end of the bridging section and extended through the second swivel ring, the second buckle, and the limiting section sequentially and fixed to the first buckle. The first buckle is movable on the first extension section. The second buckle is movable on the second extension section. A movement of the first buckle on the first extension section and a movement of the second buckle on the second extension section may adjust an overlapping length of the first extension section and the second extension section between the first buckle and the second buckle.

Based on the above, in the present application, via an additional head strap module, the risk of the host of the wearable device falling is reduced and wear stability is increased. The hollow structure of the head strap module may improve breathability and avoid the stuffy feeling after wearing for long periods of time. The head strap module only needs one-time adjustment to conform to the head shape of the user.

### BRIEF DESCRIPTION OF THE DRAWINGS

FIG. 1 is a schematic diagram of the host and the temple arms of a wearable device according to an embodiment of the invention.

FIG. 2 is a schematic diagram of the head strap module of the wearable device of FIG. 1.

FIG. 3A is a schematic diagram of the head strap module of FIG. 2 connected to the first temple arm of FIG. 1.

FIG. 3B is a schematic diagram of the head strap module of FIG. 2 connected to the second temple arm of FIG. 1.

FIG. 4A is a schematic diagram of the wearable device of FIG. 1 being worn on the head of a user.

FIG. 4B is a schematic diagram of the wearable device of FIG. 4A being worn on the head of a user and tightening the support strap.

FIG. 5 is a schematic diagram of the first connector of a wearable device connected to the first temple arm according to an embodiment of the invention.

### DESCRIPTION OF THE EMBODIMENTS

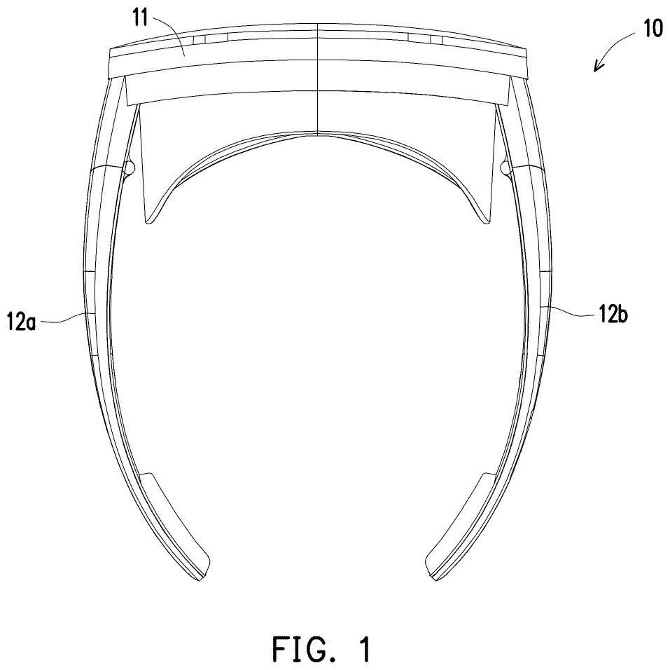

Please refer to FIG. 1. In the present embodiment, a wearable device 10 includes a host 11. The host 11 is a head-mounted display and may be applied in a field such as a virtual reality system, an augmented reality system, or a mixed reality system. The host 11 may include a member such as an optical system and a protective shell, and may be provided with a display or be suitable for placing a display. The display may be a built-in display or an external portable display (such as a smart phone, etc.), but is not limited thereto. The optical system includes an optical element used to change the optical path of a display, such as a lens, a light guide, or a prism.

Please refer to FIG. 1. In the present embodiment, the wearable device 10 further includes a first temple arm 12a and a second temple arm 12b. The first temple arm 12a and the second temple arm 12b are respectively connected to two opposite sides of the host 11. Therefore, the user may wear the host 11 on the eyes of the user via the first temple arm 12a and the second temple arm 12b in a traditional glasses wearing manner.

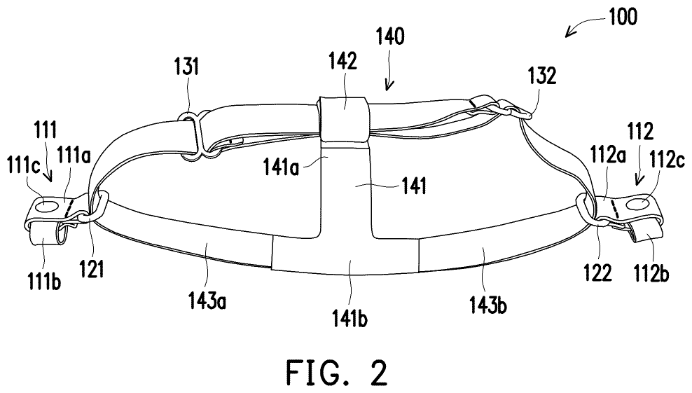

Please refer to FIG. 1 and FIG. 2. In the present embodiment, the wearable device 10 further includes a head strap module 100. The head strap module 100 includes a first connector 111, a second connector 112, a first swivel ring 121, a second swivel ring 122, a first buckle 131, a second buckle 132, and a support strap 140. The first connector 111 is detachably connected to the first temple arm 12a. The second connector 112 is detachably connected to the second temple arm 12b. The first swivel ring 121 is connected to the first connector 111. The second swivel ring 122 is connected to the second connector 112.

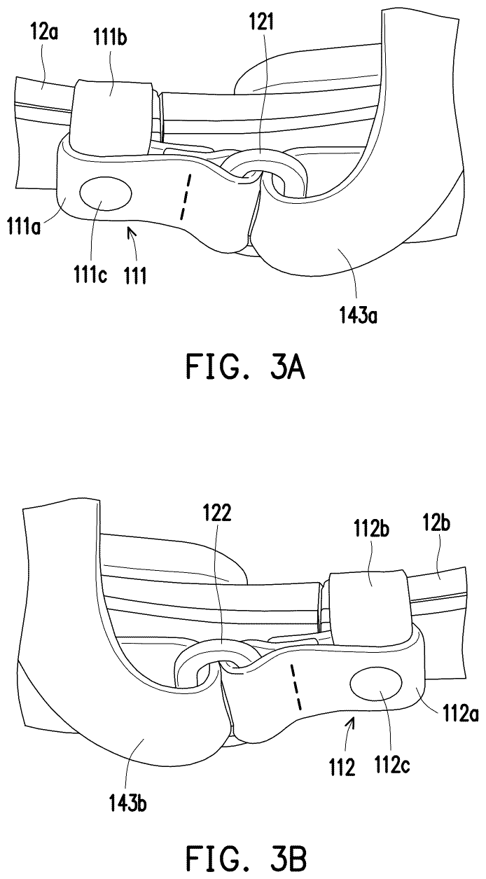

Please refer to FIG. 2, FIG. 3A, and FIG. 3B. In the present embodiment, the support strap 140 has a bridging section 141, a limiting section 142, a first extension section 143a, and a second extension section 143b. The bridging section 141, the limiting section 142, the first extension section 143a, and the second extension section 143b may be made of webbing or other soft materials. The limiting section 142 may be annular or tubular, and is located at a first end 141a of the bridging section 141. The first extension section 143a is connected to a second end 141b of the bridging section 141 relative to the first end 141a and extended through the first swivel ring 121, the first buckle 131, and the limiting section 142 sequentially and fixed to the second buckle 132. The second extension section 143b is connected to the second end 141b of the bridging section 141 and extended through the second swivel ring 122, the second buckle 132, and the limiting section 142 sequentially and fixed to the first buckle 131.

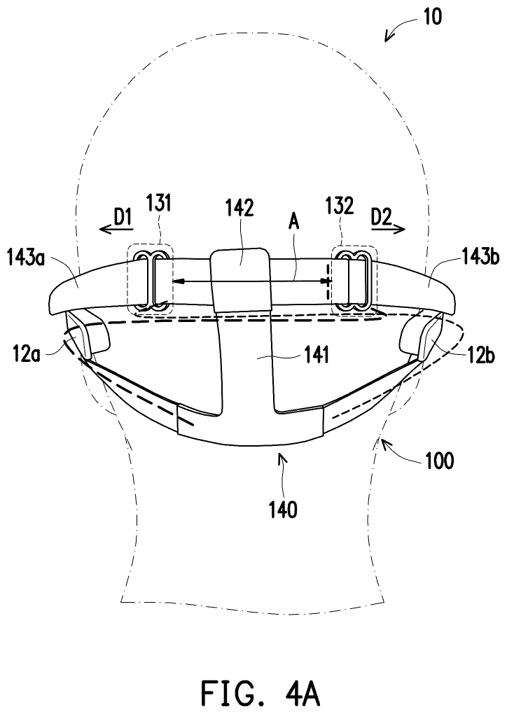

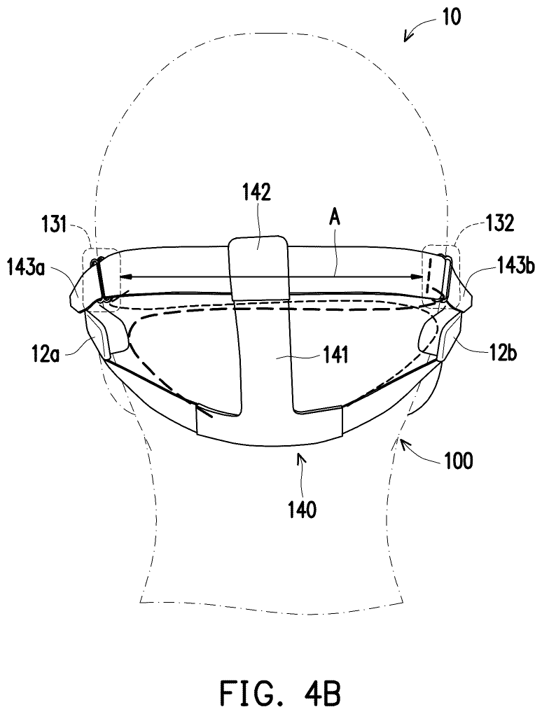

Please refer to FIG. 4A. The first connector 111 and the second connector 112 of the head strap module 100 are detachably connected to the first temple arm 12a and the second temple arm 12b respectively to unfold the support strap 140 and make the support strap 140 appear like two tiled triangles. It is worth noting that the first buckle 131 is movable on the first extension section 143a so as to move the second extension section 143b together. Similarly, the second buckle 132 is movable on the second extension section 143b to move the first extension 143a together. Therefore, the movement of the first buckle 131 on the first extension section 143a and the movement of the second buckle 132 on the second extension section 143b may adjust an overlapping length A of the first extension section 143a and the second extension section 143b between the first buckle 131 and the second buckle 132 to tighten or loosen the support strap 140.

Referring to FIG. 4B, when the first buckle 131 moves along a first direction D1 (shown in FIG. 3A) on the first extension section 143a and the second buckle 132 moves along a second direction D2 (as shown in FIG. 3A) on the second extension section 143b, the overlapping length A of the first extension section 143a and the second extension section 143b between the first buckle 131 and the second buckle 132 is increased, thereby tightening the support strap 140 to conform to the head of the user. Conversely, a reduction in the overlapping length A may relax the support strap 140 to conform to the head of the user. In other words, the user only needs to move the first buckle 131 and the second buckle 132 at the same time to adjust the support strap 140 to conform to the head of the user, thereby reducing the risk of the host 11 of the wearable device 10 falling and increasing wear stability.

Please refer to FIG. 2 and FIG. 4A. In the present embodiment, an end of the first extension section 143a may be looped around the first buckle 131 and sewn back to the first extension section 143a itself to be fixed to the first buckle 131. Similarly, an end of the second extension section 143b may be looped around the second buckle 132 and sewn back to the second extension section 143b itself to be fixed to the second buckle 132.

Please refer to FIG. 2 and FIG. 3A. In the present embodiment, the first connector 111 may have a first connecting strap 111a and a first elastic ring 111b. The first connecting strap 111a is connected to the first elastic ring 111b and the first swivel ring 121. The first elastic ring 111b encircles the first temple arm 12a. The two ends of the first connecting strap 111a are respectively looped around the first elastic ring 111b and the first swivel ring 121 and sewn back to the first connecting strap 111a itself to be connected to the first elastic ring 111b and the first swivel ring 121. The first connector 111 may further have a first riveting part 111c. The first riveting part 111c rivets the first connecting strap 111a and the first elastic ring 111b to fix the first elastic ring 111b to the first connecting strap 111a.

Please refer to FIG. 2 and FIG. 3B. In the present embodiment, the second connector 112 may have a second connecting strap 112a and a second elastic ring 112b. The second connecting strap 112a is connected to the second elastic ring 112b and the second swivel ring 122. The second elastic ring 112b encircles the second temple arm 12b. The two ends of the second connecting strap 112a are respectively looped around the second elastic ring 112b and the second swivel ring 122 and sewn back to the second connecting strap 112a itself to be connected to the second elastic ring 112b and the second swivel ring 122. The second connector 112 may further have a second riveting part 121c. The second riveting part 121c rivets the second connecting strap 112a and the second elastic ring 112b to fix the second elastic ring 112b to the second connecting strap 112a.

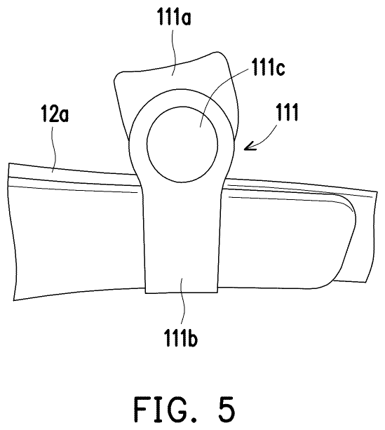

Please refer to FIG. 5. In another embodiment, the first riveting part 111c of the first connector 111 is directly riveted to the first connecting strap 111a and the first elastic ring 111b. The first elastic ring 111b encircles the first temple arm 12a. The first connecting strap 111a may be rotated relative to the first elastic ring 111b via the first riveting part 111c. Such a structural configuration may be applied to replace the structural configuration of the first connector 111 of FIG. 3A, and may also be applied to replace the structural configuration of the second connector 112 of FIG. 3B.

Based on the above, in the present application, via the additional head strap module, the risk of the host of the wearable device falling is reduced and wear stability is increased. The hollow structure of the head strap module may improve breathability and avoid the stuffy feeling after wearing for long periods of time. The head strap module only needs one-time adjustment to conform to the head shape of the user.

What is claimed is:

1. A wearable device, comprising:
a host;
a first temple arm;
a second temple arm, wherein the first temple arm and the second temple arm are respectively connected to two opposite sides of the host; and
a head strap module, comprising:
a first connector detachably connected to the first temple arm;
a second connector detachably connected to the second temple arm;
a first swivel ring connected to the first connector;
a second swivel ring connected to the second connector;
a first buckle;
a second buckle; and
a support strap having a bridging section, a limiting section, a first extension section, and a second extension section, wherein the limiting section is located at a first end of the bridging section, the first extension section is connected to a second end of the bridging section opposite to the first end and extended through the first swivel ring, the first buckle, and the limiting section sequentially and is fixed to the second buckle, the second extension section is connected to the second end of the bridging section and extended through the second swivel ring, the second buckle, and the limiting section sequentially and is fixed to the first buckle, the first buckle is movable on the first extension section, the second buckle is movable on the second extension section, and a movement of the first buckle on the first extension section and a movement of the second buckle on the second extension section may adjust an overlapping length of the first extension section and the second extension section between the first buckle and the second buckle.

2. The wearable device of claim 1, wherein an end of the first extension section is looped around the first buckle and sewn back to the first extension section itself to be fixed to the first buckle.

3. The wearable device of claim 1, wherein an end of the second extension section is looped around the second buckle and sewn back to the second extension section itself to be fixed to the second buckle.

4. The wearable device of claim 1, wherein the first connector has a first connecting strap and a first elastic ring, the first connecting strap is connected to the first elastic ring and the first swivel ring, and the first elastic ring encircles the first temple arm.

5. The wearable device of claim 4, wherein two ends of the first connecting strap are respectively looped around the first elastic ring and the first swivel ring and sewn back to the first connecting strap itself to be connected to the first elastic ring and the first swivel ring.

6. The wearable device of claim 4, wherein the first connector further has a first riveting part, and the first riveting part rivets the first connecting strap and the first elastic ring to fix the first elastic ring to the first connecting strap.

7. The wearable device of claim 1, wherein the second connector has a second connecting strap and a second elastic ring, the second connecting strap is connected to the second elastic ring and the second swivel ring, and the second elastic ring encircles the second temple arm.

8. The wearable device of claim 7, wherein two ends of the second connecting strap are respectively looped around the second elastic ring and the second swivel ring and sewn back to the second connecting strap itself to be connected to the second elastic ring and the second swivel ring.

9. The wearable device of claim 7, wherein the second connector further has a second riveting part, and the second riveting part rivets the second connecting strap and the second elastic ring to fix the second elastic ring to the second connecting strap.

10. A head strap module, suitable for a wearable device, wherein the wearable device comprises a host, a first temple arm, and a second temple arm, the first temple arm and the second temple arm are respectively connected to two opposite sides of the host, and the head strap module comprises:
a first connector suitable for being detachably connected to the first temple arm;
a second connector suitable for being detachably connected to the second temple arm;
a first swivel ring connected to the first connector;
a second swivel ring connected to the second connector;
a first buckle;
a second buckle; and
a support strap having a bridging section, a limiting section, a first extension section, and a second extension section, wherein the limiting section is located at a first end of the bridging section, the first extension section is connected to a second end of the bridging section opposite to the first end and extended through the first swivel ring, the first buckle, and the limiting section sequentially and is fixed to the second buckle, the second extension section is connected to the second end of the bridging section and extended through the second swivel ring, the second buckle, and the limiting section sequentially and is fixed to the first buckle, the first buckle is movable on the first extension section, the second buckle is movable on the second extension section, and a movement of the first buckle on the first extension section and a movement of the second buckle on the second extension section may adjust an overlapping length of the first extension section and the second extension section between the first buckle and the second buckle.

11. The head strap module of claim 10, wherein an end of the first extension section is looped around the first buckle and sewn back to the first extension section itself to be fixed to the first buckle.

12. The head strap module of claim 10, wherein an end of the second extension section is looped around the second buckle and sewn back to the second extension section itself to be fixed to the second buckle.

13. The head strap module of claim 10, wherein the first connector has a first connecting strap and a first elastic ring, the first connecting strap is connected to the first elastic ring and the first swivel ring, and the first elastic ring is suitable for encircling the first temple arm.

14. The head strap module of claim 13, wherein two ends of the first connecting strap are respectively looped around the first elastic ring and the first swivel ring and sewn back to the first connecting strap itself to be connected to the first elastic ring and the first swivel ring.

15. The head strap module of claim 13, wherein the first connector further has a first riveting part, and the first riveting part rivets the first connecting strap and the first elastic ring to fix the first elastic ring to the first connecting strap.

16. The head strap module of claim 10, wherein the second connector has a second connecting strap and a second elastic ring, the second connecting strap is connected to the second elastic ring and the second swivel ring, and the second elastic ring is suitable for encircling the second temple arm.

17. The head strap module of claim 16, wherein two ends of the second connecting strap are respectively looped around the second elastic ring and the second swivel ring and sewn back to the second connecting strap itself to be connected to the second elastic ring and the second swivel ring.

18. The head strap module of claim 16, wherein the second connector further has a second riveting part, and the second riveting part rivets the second connecting strap and the second elastic ring to fix the second elastic ring to the second connecting strap.
